(19) United States
(12) Patent Application Publication
(10) Pub. No.: US 2016/0189271 A1
(43) Pub. Date: Jun. 30, 2016

(54) Real estate buyer lead generation system

(71) Applicant: Douglas Cutting, Daniel Island, SC (US)

(72) Inventor: Douglas Cutting, Daniel Island, SC (US)

(21) Appl. No.: 14/757,898

(22) Filed: Dec. 24, 2015

Related U.S. Application Data
(60) Provisional application No. 62/096,610, filed on Dec. 24, 2014.

(51) Int. Cl. G06Q 30/06; G06Q 50/16

(52) U.S. Cl. CPC G06Q 30/0625; G06Q 50/167

(57) ABSTRACT

Novel real estate lead generation method leveraging buyers' desired property specifications, as opposed to only property listings, which increases the effectiveness of the real estate search process and facilitates connections between buyers and sellers for pocket listings and off-market properties.

### CROSS-REFERENCE TO RELATED APPLICATIONS

U.S. Provisional App. 62/096,610

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

The inventive subject matter relates to a real estate lead generation method.

### BACKGROUND OF THE INVENTION

The existing practice of marketing real estate online does not leverage the value of ascertainable information about buyers. Sellers, or more often their real estate agents, simply list property to be sold on one or more websites. Buyers and their agents then have to search through the property listings on such websites, identify property listings that meet the buyers' desired specifications, and contact the sellers and their agents to pursue any particular property.

The effectiveness of this existing practice is inherently limited by the exhaustible labor of the buyers and their agents, who in many cases are unlikely to be able to personally search for and identify all of the property listings that meet the buyer's desired specifications. The effectiveness of this existing practice is also inherently limited because it only involves the closed universe of properties that are actually listed for sale; it does not create opportunities for the sale of “pocket” listings and off-market properties. The end result of this existing practice is that much labor is exerted by buyers and their agents, and nevertheless, many buyers may never learn about properties they could have purchased that would have met their desired specifications. There is a commercial need for a new method that overcomes these limitations and generates real estate leads more effectively.

Patents that have been issued for lead generation systems and methods do not address or provide solutions for these limitations: for example, U.S. Pat. No. 8,660,792 (“Systems and method for prioritizing real estate opportunities in a lead handling system based on lead quality and opportunity scores”); and U.S. Pat. No. 8,566,141 (“System and method of applying custom lead generation criteria”).

All patents and patent applications referenced herein are incorporated in their entirety. Where a definition or use of a term in a reference is inconsistent or contrary to the definition or use of that term herein, the definition or use of the term herein shall apply.

### BRIEF SUMMARY OF THE INVENTION

The present invention is directed to a novel method of generating real estate leads that leverages the buyers' desired property specifications, as opposed to the properties that are listed for sale. Using an online computer system, buyers and their agents register and input the buyers' desired property specifications, such as geography, budget, and size. Sellers and their agents register and input reciprocal specifications of interest. Inputs from the buyers and sellers and their agents are compared and relevant matches are determined according to an algorithm. An electronic notice is provided whenever a new relevant match is introduced into the system. Additionally, the buyers' desired property specifications are published and made accessible and searchable by any interested member the public, who can communicate electronically with any the registered buyers and buyers' agents of interest.

The invention overcomes or at least vastly improves the labor limitation of the existing practice. The invention leverages the labor of sellers and their agents as well as any interested members of the public, whose participation multiplies, by factors, the total labor expended toward satisfying the buyers' desired property specifications.

The invention also overcomes or at least vastly improves the limitation of the existing practice that arises from its closed universe of properties listed for sale. Presenting the buyers' desired specifications to the market, per the invention, creates opportunities for the sale of “pocket” listings and off-market properties.

In sum, the invention generates real estate leads more efficiently than the existing practice, improves the likelihood that buyers will find properties that meet their desired specifications, and provides a new way to open up the real estate market beyond properties that are actually listed for sale.

Various additional objects, features, aspects, and advantages of the present invention will become more apparent from the following detailed description of preferred embodiments of the invention, along with the accompanying drawing in which like numerals represent like components.

### BRIEF DESCRIPTION OF THE SEVERAL VIEWS OF THE DRAWING

FIG. 1 is a flow chart that shows one embodiment of the invention.

FIG. 2 is a flow chart that shows additional features of the embodiment of the invention shown in FIG. 1.

FIG. 3 is a diagram that shows the advantages of the invention vis-à-vis the existing practice of marketing real estate online.

### DETAILED DESCRIPTION OF THE INVENTION

There are many possible embodiments of the invention, some of which are described below.

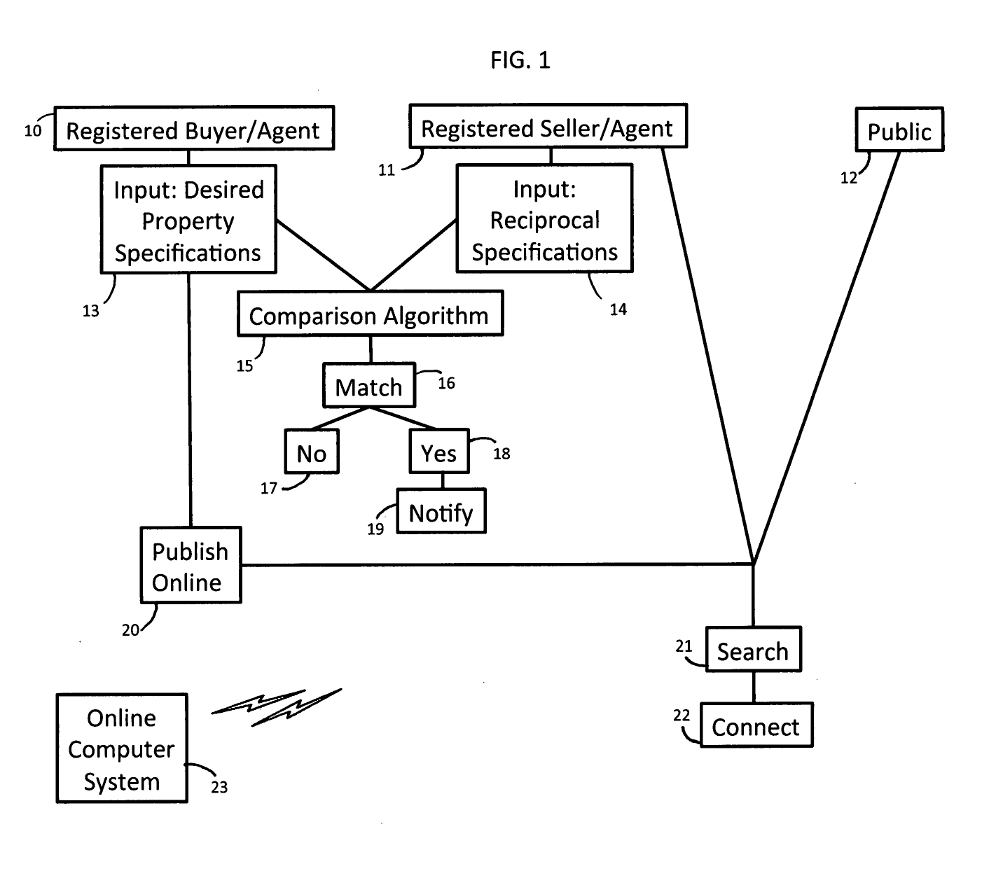

In further detail, FIG. 1 is a flow chart that shows one embodiment of the invention. Registered Buyer/Agent 10 represents the step of registering participating buyers and buyers' agents in the Online Computer System 23. Registered Seller/Agent 11 represents the step of registering participating sellers and sellers' agents in the in the Online Computer System 23. Public 12 represents the step of making the Online Computer System 23 accessible by any member of the public. Input: Desired Property Specifications 13 represents the step of requiring information, the buyers' desired property specifications, to be input into the Online Computer System 23 by Registered Buyer/Agent 10. Input: Reciprocal Specifications 14 represents the step of requiring information, specifications reciprocal in nature to the buyers' desired property specifications, to be input into Online Computer System 23 by Registered Seller/Agent 11. Comparison Algorithm 15 represents the step of running a comparison algorithm in the Online Computer System 23 every time any new information is input, to determine whether there is a new match between the Input: Desired Property Specifications 13 and the Input: Reciprocal Specifications 14, and ultimately determining the answer to whether there is Match 16, which can be either No 17 or Yes 18. If Yes 18, then Notify 19 represents the step of notifying, by an electronic communication generated in the Online Computer System 23, the registered participating buyers and buyers' agents and the registered participating sellers and sellers' agents of any new match relating to their respective specifications. Examples of comparison algorithms that could be used to determine the existence of a match include: where any one of the buyers' desired property specifications and the sellers' reciprocal specifications input are the same; where a plurality of the buyers' desired property specifications and sellers' reciprocal specifications input are the same; where only certain of the buyers' desired property specifications and sellers' reciprocal specifications input are the same. It should be understood that additional alternative comparison algorithms could be used in practicing the invention to determine whether there is a match. Publish Online 20 represents the step of publishing the Input: Buyers' Desired Property Specifications 13 in the Online Computer System 23, such that they are accessible by the Registered Seller/Agent 11 and any interested member the Public 12. Search 21 represents the step of allowing the Registered Seller/Agent 11 and any interested member the Public 12 to search through the desired property specifications in the Online Computer System 23. Connect 22 represents the step of connecting the Registered Seller/Agent 11 and any interested member the Public 12, by an electronic communication generated in the Online Computer System 23, to the Registered Buyer/Agent 10.

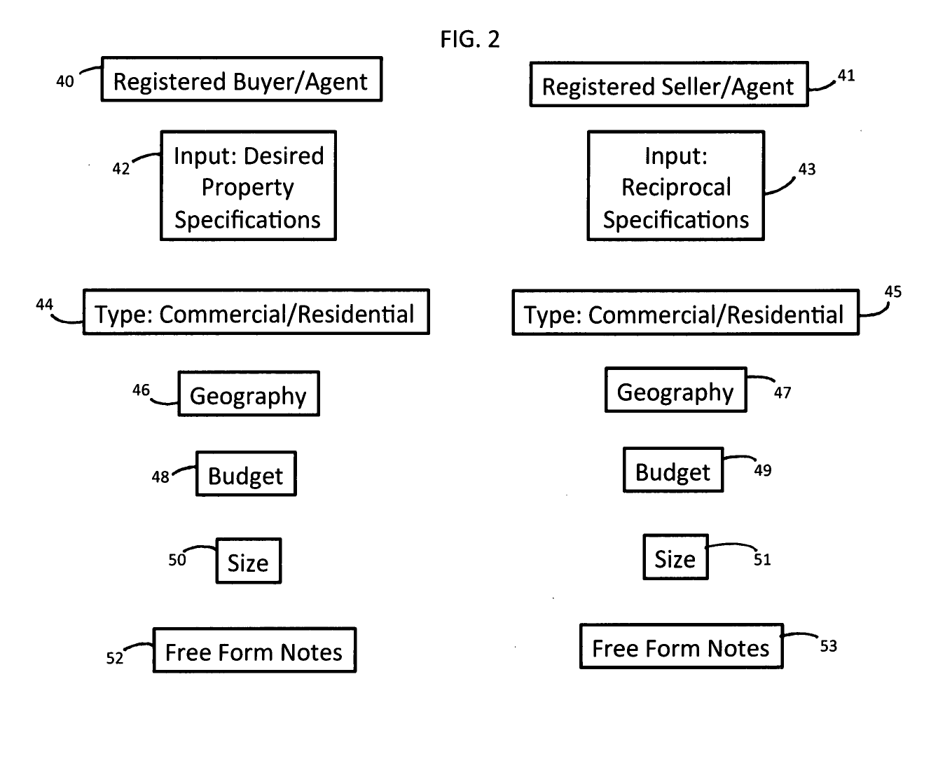

In further detail, FIG. 2 is a flow chart that shows additional details of the embodiment of the invention shown in FIG. 1. Registered Buyer/Agent 40 is the same as 10 in FIG. 1. Registered Seller/Agent 41 is the same as 11 in FIG. 1. Input: Desired Property Specifications 42 is the same as 13 in FIG. 1. Input: Reciprocal Specifications 43 is the same as 14 in FIG. 1. The remaining elements in FIG. 2 represent examples of Input: Desired Property Specifications 42 and Input: Reciprocal Specifications 43, including: Type Commercial/Residential 44 and 45, which represents a choice between commercial and residential property; Budget 48 and 49, which represents a desired price or price range; Size 50 and 51, which represents the size of a desired property; and Free Form Notes 52 and 53, which allow any additional information to be input, such as “fenced yard” or “intersection frontage.” These are mere examples of desired property specifications and reciprocal specifications. It should be understand that there are many additional desired property features and characteristics that are contemplated by the invention.

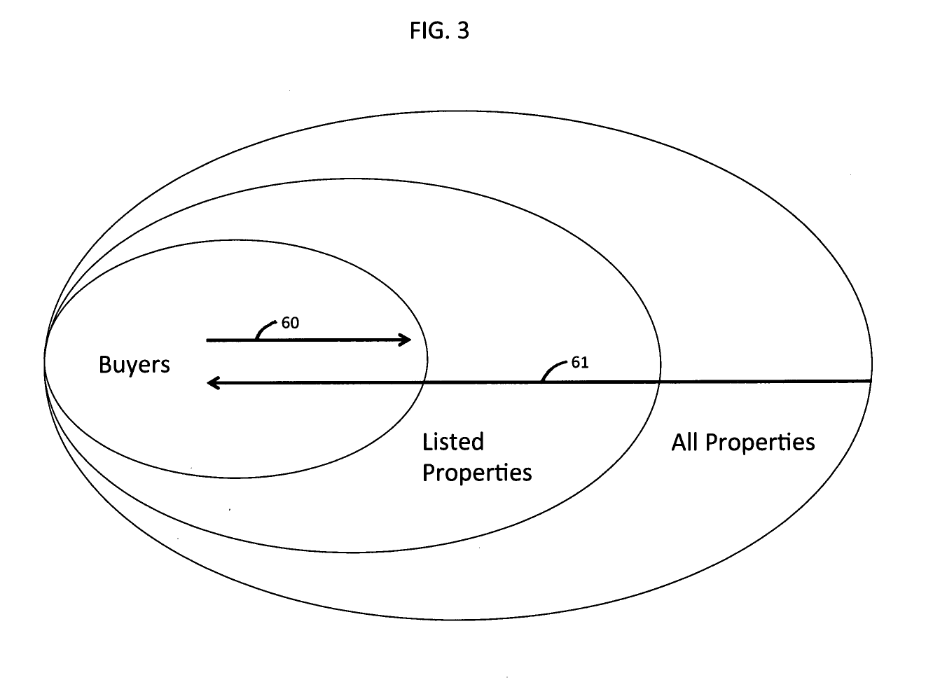

In further detail, FIG. 3 is a diagram that shows the advantages of the invention vis-à-vis the existing practice of marketing real estate online. The arrow 60 represents the inherent limitations in the existing practice, demonstrating that buyers are unlikely to find all properties, listed or unlisted, which satisfy their desired property specifications. The arrow 61 represents the advantages of the invention, whereby sellers and their agents and members of the public focus on the buyers' desired property specifications, and present relevant listed and unlisted properties to the buyer.

It should be understood that the invention can also be employed in the real estate rental market, such that renters would play the role of buyers, as described herein, and landlords would play the role of sellers, as described herein.

While the foregoing written description of the invention enables one of ordinary skill to make and use what is considered presently to be the best mode thereof, those of ordinary skill will understand and appreciate the existence of variations, combinations, and equivalents of these specific embodiments. The invention should therefore not be limited by the above described embodiments, but shall include all embodiments within the scope and spirit of the invention.

1. A novel method for generating real estate leads comprising:
a. registering participating buyers and buyers' agents in an online computer system by requiring them to input information comprising:
desired property specifications;
b. registering participating sellers and sellers' agents in the online computer system by requiring them to input information comprising:
reciprocal specifications of interest;
c. running a comparison algorithm in the online computer system every time any new information is input into the online computer system, to determine whether there is a new match between any of the desired property specifications and the reciprocal specifications of interest;
d. notifying, by an electronic communication generated in the online computer system, the registered participating buyers and buyers' agents and the registered participating sellers and sellers' agents of any new match relating to their respective specifications;
e. publishing the desired property specifications in the online computer system, such that they are accessible and searchable by any interested member the public; and
f. connecting, by an electronic communication generated in the online computer system, any interested member of the public to the registered participating buyers and buyers' agents.
